(19) United States
(12) Patent Application Publication
(10) Pub. No.: US 2024/0343010 A1
(43) Pub. Date: Oct. 17, 2024

(54) MOUNTING DEVICE AND USE OF THE MOUNTING DEVICE FOR MOUNTING ELECTROLYSIS CELLS OF AN ELECTROLYSER

(71) Applicant: Siemens Energy Global GmbH & Co. KG, München (DE)

(72) Inventor: Erik Wolf, Röttenbach (DE)

(21) Appl. No.: 18/572,880

(22) PCT Filed: Jun. 15, 2022
(86) PCT No.: PCT/EP2022/066374

§ 371 Date: Jul. 2, 2024

(30) Foreign Application Priority Data
Jun. 30, 2021 (EP) 21182760.5

(51) Int. Cl. B30B 9/28; B30B 1/32; B30B 15/00; B30B 15/04; C25B 9/73; C25B 9/77

(52) U.S. Cl. CPC B30B 9/28; B30B 1/32; B30B 15/0094; B30B 15/045; C25B 9/73; C25B 9/77

(57) ABSTRACT

The invention relates to a mounting device for use in an electrolyser for mechanically pressing a plurality of electrolysis cells, which are centered in relation to each other in the axial direction by means of a centering linkage to form an electrolysis stack, by applying an axial force (F), said mounting device comprising a hydraulic assembly having a pressure plate, an actuator, and a receptacle, the receptacle having a number of connecting elements located on the periphery of the pressure plate for detachable connection to the electrolysis stack in such a way that, when the hydraulic assembly is activated by the axial force (F), the mechanical pressing can be carried out. The invention also relates to the use of a mounting device for mounting electrolysis cells of an electrolyser.

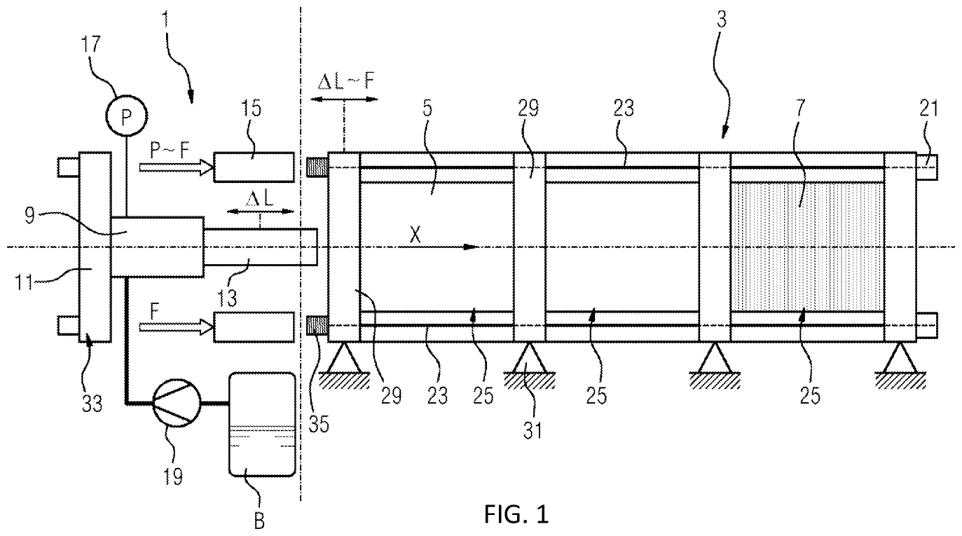

Mounting device and use of the mounting device for mounting electrolysis cells of an electrolyser

The invention relates to a mounting device and the use of the mounting device for mounting electrolysis cells in an electrolyzer.

An electrolyzer is a device which uses electric current to bring about chemical change (electrolysis). Corresponding to the numerous types of electrolysis, there are also a multitude of electrolyzers, for example an electrolyzer for water electrolysis.

Current thinking considers using excess energy from renewable energy sources to generate valuable substances during times when there is plenty of sun and plenty of wind, i.e. when the solar electricity or wind power generated is above average. A valuable substance may be, in particular, hydrogen, which is generated using water electrolyzers. The hydrogen may be used to produce so-called EE gas, for example.

An electrolyzer generally has a plurality of electrolysis cells, which are arranged adjacent to one another. Water is separated into hydrogen and oxygen in the electrolysis cells via water electrolysis. In a PEM electrolyzer, distilled water is typically supplied as a reagent on the anode side and split into hydrogen and oxygen at a proton exchange membrane (PEM). The water is oxidized to oxygen at the anode. The protons pass through the proton exchange membrane. Hydrogen is produced on the cathode side. The water here is generally delivered into the anode chamber and/or cathode chamber from a bottom side.

In an electrolyzer, the individual electrolysis cells are typically stacked in an axial direction to form a segment comprising a plurality of individual cells and are used to build the segment. An electrolyzer here conventionally has multiple segments, which together form the so-called electrolysis stack or simply “stack”. For example, 50 electrolysis cells may be stacked axially to form a segment and, for example, 5 segments may in turn be stacked in the axial direction to form a stack, which means that such an electrolysis stack therefore comprises, for example, 250 cells in the axial overall structure.

So that the axial overall structure comprising the cells is functionally capable of operating at a desired operating pressure of the electrolyzer, the cells must be sealed with respect to one another for the transportation of fluids and, at the same time, good electrical contacting of adjacent cells must be ensured for the electrical voltage supply across the cells. This is conventionally achieved in that, when assembling the electrolyzer, an axial force is applied to the cells in order to achieve sufficient surface pressure so that both the desired mechanical tensioning for fluid-mechanical sealing of the electrolysis stack and the required electrical contacting are ensured. To apply and adjust the axial force component and permanently maintain the surface pressure and monitor this for changes in an electrolysis stack, very complex and specifically configured pressing and tensioning devices, assembly aids and monitoring devices are used, which is very cost-intensive.

A pressing and securing device of this type is described, for example, in WO 2020/203319 A1 as part of an electrolyzer. In this, a plurality of electrolysis cells of an electrolyzer is tightly packed and positioned in an axial stack direction to form a cell stack. An axial pressing force is applied to the cell stack by a pressing device which is integrated in the surrounding housing of the electrolyzer and the desired pressing force is set and maintained. The pressing device here surrounds the whole cell stack. The pressing device has a respective end plate at the axial ends of the cell stack, which end plates are movable relative to one another and, at the same time, function as an actuator or counter bearing. This brings about the axial pressing force, which is fixed so that the surface pressure on the cells is permanently maintained.

The object of the present invention, therefore, is to enable cost-effective and operationally reliable assembly of an electrolysis stack.

The said object is achieved by a mounting device according to the invention in accordance with the teaching of claim 1. The use according to the invention of the mounting device is specified in claim 6. Advantageous embodiments are the subject matter of the independent claims.

The invention here starts with the recognition that, for initial assembly and with regard to future servicing purposes, the previously known devices for mechanically tensioning or relaxing the stack are very disadvantageous, especially due to the high costs and the lack of flexibility. Since the areas in which electrolyzers are used are expected to increase significantly in the future, with increased power and greater demand for electrolyzers on an industrial scale, there is therefore a significant need to overcome these disadvantages and, at the same time, enable high operational reliability and flexibility in terms of servicing and maintenance. This is particularly relevant for high-pressure electrolysis at operating pressures of approximately 20-30 bar and above. A pressure—and fluid—tight mechanical design and electrical interconnection of the cells are particularly important here.

The invention recognizes and overcomes the above disadvantages in a particularly advantageous manner for the first time by proposing a flexible and especially separate mounting device as an independent, e unit and tool for applying the necessary axial force components to a pre-assembled electrolysis stack during assembly, and thus overcomes the disadvantages of an integral and permanent installation of the mounting device and proposes a releasable connection. As a result, a reduction in the complexity of the system as a whole is achieved and installation space or the installation length of the arrangement is reduced, which in turn has cost advantages. The mounting device no longer has to remain on the electrolyzer as an integral part of the arrangement, as was previously the case. Due to the releasable connection-used merely for mounting purposes—the mounting device according to the invention can therefore be used repeatedly for initial manufacture and for setting the desired mechanical compression in a plurality of electrolysis stacks. The repeated use of the mounting device has significant cost advantages for the series manufacture of electrolyzers in the high numbers to be expected in the future. In addition to this, the mounting device is easy to transport and can be mechanically connected to another electrolyzer if required. This enables the mounting device to be used during servicing, in order to enable checking and adjustments to be carried out.

The application of the axial force component is achieved by the hydraulic assembly here. The hydraulic pressure of the hydraulic assembly serves as a direct indicator of the tensioned state or the axial force needed to achieve the desired surface pressure, which can be set in a precise and reproducible manner and with high reliability and quality. For this purpose, when connecting the receptacle of the mounting device to the electrolysis stack and activating the hydraulic assembly, this latter is supported against the pressure plate, whereas the actuator applies the hydraulically induced pressure force to the electrolysis stack in the axial direction and compresses this electrolysis stack axially in order to achieve the desired surface pressure. As a result, the overall structure comprising the plurality of cells in the electrolysis stack is functionally capable of operating under a desired operating pressure of the electrolyzer. This tensioned state of the electrolysis stack may be maintained using a suitable screw connection or securing elements in the electrolysis stack and the receptacles or the connecting elements of the receptacle of the mounting device may then be released again in order to remove the mounting device from the electrolysis stack. It is advantageous that the mounting device is not permanently responsible for maintaining the surface pressure and does not need to remain on the stack. It may be supplied for other uses of this type, i.e. the mounting device may be used for adjustments during the initial assembly and initial operation of electrolyzers and for the servicing and maintenance of existing electrolyzers.

The mounting device here is designed, in particular, for assembling an electrolyzer comprising a number of electrolysis cells which are stacked in an axial direction such that they are centered with respect to one another by means of a centering linkage to form an electrolysis stack and can be used for releasable fastening and compression. In this type of electrolysis stack, the centering linkage conventionally has a number of axially parallel rods, which are arranged-preferably symmetrically—at the periphery of the electrolysis stack so that precise engagement and, if necessary, fastening of the mounting device can be achieved. The coupling via the connecting elements at the periphery of the pressure plate makes access and handling significantly easier, and therefore facilitates the assembly, operation and simple dismantling after the desired pressure has been applied. The mounting device enables flexible adaptation of the respective centering linkage to different geometries.

The receptacle therefore advantageously has a number of connecting elements arranged at the periphery of the pressure plate according to the configuration of the electrolysis stack. These connecting elements are configured for releasable connection to the electrolysis stack so that the mechanical compression of the electrolysis stack 5 can be brought about upon the activation of the hydraulic assembly due to the axial force F.

The cells of the electrolysis stack are thus sealed with respect to one another both for the transportation of fluids under pressure and for ensuring good electrical contacting of adjacent cells for the electrical voltage supply across the cells during operation. This is particularly advantageous for use in high-pressure electrolyzers at high operating pressures of approximately 20-30 bar and above. In this case, due to use of the mounting device with the releasable hydraulic assembly, a particularly compact design of the electrolyzer is realized, which saves on installation space and therefore reduces costs.

In the mounting device, the receptacle advantageously has a releasable screw connection. The receptacle is, in particular, configured as a sleeve with an internal thread. With a releasable screw connection, the receptacle of the mounting device enables the releasable connection of the mounting device and the electrolysis stack for the purpose of applying the surface pressure upon the activation of the hydraulic assembly. Other connecting elements which enable a connection depending on the configuration of the electrolysis stack are also possible. For example, at the end of the electrolysis stack, threaded rods may be present, which enable a simple releasable screw connection to a sleeve with an internal thread or to a nut or to a similarly acting releasable connecting element.

In a particularly advantageous configuration of the mounting device, the pressure plate is designed in such a way that it forms the fixed bearing against which the hydraulic assembly is supported upon the activation of the hydraulic assembly. As a result, the axial force acts on the electrolysis stack via the movable actuator and compresses this electrolysis stack according to the axial movement of the actuator by the amount of the actuating distance, which brings about a surface pressure on the plurality of cells. The fixed bearing forms the fixing point and is stationary.

In a further advantageous configuration, a pressure measuring device is provided for setting the axial force (F) via the hydraulic pressure.

As a result, precise monitoring of the pressing procedure upon the activation of the hydraulic assembly is realized via a pressure display and the desired pressing force can be monitored and adjusted. The pressure is proportional to the axial force and therefore to the adjustment distance or compression distance of the electrolysis stack to which this axial force is applied via the actuator.

A hydraulic pump which can deliver an operating medium is furthermore advantageously provided for activation purposes. The operating medium here is held in a reservoir and is delivered to the actuator under pressure by the pump as required in order to move the actuator against the hydraulic stack in the axial direction with hydraulic force. A hydraulic oil is used as the operating medium.

The mounting device is particularly advantageously used according to the invention when mounting electrolysis cells of an electrolyzer. It is particularly advantageously used when assembling or servicing a high-pressure electrolyzer with high operating pressures of approximately 20-30 bar and above during operation.

A particularly preferred use of the mounting device according to the invention is specified in electrolyzers in which a plurality of electrolysis cells are arranged such that they are centered with respect to one another in the axial direction to form an electrolysis stack, wherein the hydraulic assembly is mechanically connected to the electrolysis stack in such a way that, upon the activation of the hydraulic assembly, mechanical compression of the electrolysis stack is brought about by an axial force. This is one particular application.

In a further preferred use, the axial force here is adjusted until a predetermined tensioned state is achieved due to the surface pressure of the electrolysis cells (7) in the electrolysis stack.

In a preferred use, the tensioned state of the electrolysis stack is secured, in particular for subsequent operation. Securing elements on the electrolysis stack, for example screws, are specifically used to secure the tensioned state. Conversely, the mounting device itself does not perform a permanent securing task and may be advantageously used for other assembly and servicing work in electrolyzers.

To this end, in a particularly preferred use, the mechanical connection between the hydraulic assembly and the electrolysis stack is released after the tensioned state has been secured. The mounting device is therefore available for the further applications described above.

In a particularly preferred use, the mounting device is used in an electrolysis stack comprising a plurality of electrolysis cells which are tightly stacked along the axial direction by means of a centering linkage. During the assembly of the electrolyzer, the cells are arranged successively on the centering linkage and stacked to form segments, and multiple segments are brought together on the centering linkage to form a stack. The centering linkage comprises multiple metal rods, for example, which may have threaded portions, preferably at their ends, for fixing the tension. 50 electrolysis cells, for example, may thus be stacked axially to form a segment and 5 segments, for example, may in turn be stacked in the axial direction to form a stack so that such an electrolysis stack therefore comprises 250 cells in an axial overall structure. The numbers are merely exemplary and may also vary depending on the design and construction of the electrolyzer. Of particular advantage is the highly flexible way in which the use of the mounting device can be substantially independently and easily adapted to specific structural configurations and conditions for different designs of electrolysis cells which are stacked axially to form an electrolysis stack.

In a particularly preferred use, the centering linkage has a number of axially parallel rods, which are arranged at the periphery of the electrolysis stack. The centering linkage is designed, for example, as a number of cylindrical metal rods, in particular four metal rods, which ensure good stackability of a plurality of electrolysis cells along with mechanical stability in the cell group. The rods have, in particular, as smooth—and preferably polished-a surface as possible, which makes the stacking or the axial arrangement of the cells above one another or axially adjacent to one another significantly easier during the manufacture. This may be adapted to the cell geometry. For example four axially parallel rods are preferred here if, for instance, the identical electrolysis cells each form a square or rectangular surface perpendicular to the stacking direction, and therefore the axial direction. However, depending on the cell geometry, other constructions in terms of the number and arrangement of the rods of the centering linkage are also possible.

In the following FIGURE, a mounting device according to the invention and the use thereof in an electrolyzer are depicted by way of example. In this regard, the

FIGURE shows a longitudinal section through an electrolyzer with a mechanically connected mounting device.

The FIGURE shows an electrolyzer 3, which extends along a longitudinal axis X and is aligned linearly along this axis. The electrolyzer 3 has an electrolysis stack 5. The electrolysis stack 5 comprises three substantially identical sub-assemblies, the segments 25, which are arranged in succession along the longitudinal axis X. Each of the segments 25 here has a plurality of electrolysis cells 7 stacked along the longitudinal axis X. Each segment 25 is delimited axially at the top by an end plate 29 and axially at the bottom by an end plate 29. The end plates 29 enclose the electrolysis cells 7 of the respective segment 25 and delimit this sub-assembly.

In the electrolyzer 3, fifty electrolysis cells, for example, are thus stacked axially to form a segment 25 and five segments, for example, are in turn stacked in the axial direction to form an electrolysis stack 5, so that such an electrolysis stack 5 therefore comprises, for example, 250 cells in an axial overall structure. The numbers are purely exemplary and other numbers may be chosen depending on the design and construction of the electrolyzer. For reasons of clarity, three segments 25 are therefore shown in the FIGURE. However, this configuration can be scaled and adapted to the respective requirements of specific applications.

In the electrolysis stack 5, the plurality of electrolysis cells 5 is tightly stacked along the axial direction by means of a centering rod 21 so that, together with the end plates 29, a cell group is formed as part of the electrolysis stack 5. In the exemplary embodiment, the centering linkage 21 has four axially parallel rods 23, which are arranged at the periphery of the electrolysis stack 5. For the operation of the electrolyzer 3, this cell group in the electrolysis stack 5 should be formed such that it is pressure-tight for the operating medium and the electrolysis products, for instance water for water electrolysis with hydrogen and oxygen as the product gases. For operation, very good and especially uniform electrical contacting between the adjacent electrolysis cells 7 should furthermore be realized for loss-free electrical series connection.

The electrolyzer 3 as a whole is mounted on a bearing 31, a so-called floating bearing, via solid metallic end plates 29 of the electrolysis stack 5 and is accordingly movable or displaceable along the longitudinal axis. The bearing 31 here permits axial displacements of the electrolysis stack 5 as a whole, such as those caused by temperature-related longitudinal expansions during operation, for instance, or—as is significant for the present invention—by external mechanical compression of the electrolysis stack 5 via an externally applied axial force F for initial assembly or for servicing, depending on requirements.

To enable the necessary mechanical compression as required and in a flexible manner and to adjust it for the operation of the electrolysis stack 5, the mounting device 1 is advantageously assembled accordingly: to this end, the mounting device comprises a hydraulic assembly 9 having a pressure plate 11, having an actuator 13 and having a receptacle 15 for releasable connection to the electrolysis stack 5. The mechanical compression of the electrolysis stack 5 can be brought about upon the activation of the hydraulic assembly due to the axial force F. The pressure plate 11 is designed in such a way that it forms a fixed bearing 33 so that the hydraulic assembly 9 is supported against the fixed bearing 33 upon the activation of the hydraulic assembly 9. The receptacle 15 is designed as a releasable screw connection in the form of a sleeve, which engages in a corresponding thread 35 of the electrolysis stack 5 in the assembled state and surrounds this thread. In the present case, the receptacle 15 is configured as a sleeve with a corresponding internal thread. In the mounting device 1, alternative options for releasable connecting elements and the arrangement thereof are conceivable for realizing the receptacle 15. In the exemplary embodiment, the actuator 13 as part of the hydraulic assembly 9 is arranged centrally on the pressure plate 11, and the connecting elements of the receptacle 15, in the present case a releasable screw connection comprising sleeves, are placed around the central actuator 13. In the case of the receptacle 15 in the FIGURE, the connecting elements are placed or arranged symmetrically at the periphery of the pressure plate 11, so that precise engagement or a releasable connection with the centering linkage 21 of the electrolysis stack 5 is provided, which is particularly advantageous for uniform compression and axial guidance during the engagement.

To monitor the pressure and set the desired axial force F via the hydraulic pressure, a pressure measuring device 17 is provided. A hydraulic pump 19 ensures the desired pressure level for activating the pressing procedure and delivers the operating medium B, for instance a hydraulic oil, under pressure P for hydraulically driving the actuator 13. This can bring about a pre-determinable axial displacement Δ1 of the actuator 13, which is proportional to the axial force F or to the pressure P, so that a predetermined mechanical compression of the electrolysis stack 5 is brought about upon the activation of the hydraulic assembly 19 due to the axial force F. If the desired tensioned state of the electrolysis stack 5 is achieved, this tensioned state of the electrolysis stack is secured and maintained. Typically, surface pressures in the range of approximately 10-100 N/cm², preferably approximately 40-60 N/cm², may be set. Greater surface pressures may also be applied.

By means of the invention, the overall structure of the plurality of electrolysis cells 7 in the electrolysis stack 5 is established by means of the mounting device 1 such that it is functional and ready for operation under a desired operating pressure of the electrolyzer 3. This tensioned state of the electrolysis stack 5 is secured by means of a suitable screw connection or securing elements in the electrolysis stack 5 and the receptacle 15 of the mounting device 1 is subsequently released again in order to remove the mounting device 1 from the electrolysis stack 5. The mounting device 1 itself does not have to be permanently responsible for maintaining or fixing the surface pressure of the electrolysis stack 5. The mounting device does not remain on the electrolysis stack 5, which is very advantageous. It is supplied for other uses of this type, i.e. the mounting device 1 may be used in a flexible manner for adjustments during the initial assembly and initial operation of further electrolyzers, and, in particular, also for servicing, for diagnostics relating to the tensioned state and for maintenance of electrolyzers 5 which are already in operation.

1. A mounting device for use in an electrolyzer for mechanical compression of a plurality of electrolysis cells arranged such that they are centered with respect to one another in the axial direction to form an electrolysis stack due to the application of an axial force (F), comprising a hydraulic assembly having a pressure plate, having an actuator and having a receptacle, wherein the receptacle has a number of connecting elements arranged at the periphery of the pressure plate for releasable connection to the electrolysis stack in such a way that the mechanical compression of the electrolysis stack can be brought about upon the activation of the hydraulic assembly due to the axial force (F).

2. The mounting device as claimed in claim 1, wherein the actuator is arranged centrally on the pressure plate, and the connecting elements of the receptacle are placed around the central actuator.

3. The mounting device as claimed in claim 1, wherein, in the case of the receptacle, the connecting elements are placed symmetrically at the periphery of the pressure plate.

4. The mounting device as claimed in claim 1, wherein the receptacle has a releasable screw connection, which is, in particular, configured as a sleeve with an internal thread.

5. The mounting device as claimed in claim 1, wherein the pressure plate is designed in such a way that it forms the fixed bearing against which the hydraulic assembly is supported upon the activation of the hydraulic assembly.

6. The mounting device as claimed in claim 1, wherein a pressure measuring device is provided for setting the axial force (F) via the hydraulic pressure.

7. The mounting device as claimed in claim 1, wherein a hydraulic pump which can deliver an operating medium (B) is furthermore provided for activation purposes.

8. (canceled)

9. The mounting device as claimed in claim 1, wherein a plurality of electrolysis cells are arranged such that they are centered with respect to one another in the axial direction to form an electrolysis stack, wherein the hydraulic assembly is mechanically connected to the electrolysis stack in such a way that, upon the activation of the hydraulic assembly, mechanical compression of the electrolysis stack is brought about by an axial force (F).

10. The mounting device as claimed in claim 9, wherein the axial force (F) is adjusted until a predetermined tensioned state is achieved due to the surface pressure of the electrolysis cells in the electrolysis stack.

11. The mounting device as claimed in claim 9, wherein the tensioned state of the electrolysis stack is secured.

12. The mounting device as claimed in claim 9, wherein the mechanical connection between the hydraulic assembly and the electrolysis stack is released after the tensioned state has been secured.

13. The mounting device as claimed in claim 9, wherein the mounting device is disposed in an electrolysis stack comprising a plurality of electrolysis cells, which are tightly stacked along the axial direction by means of a centering linkage.

14. The mounting device as claimed in claim 12, wherein the centering linkage has a number of axially parallel rods, which are arranged at the periphery of the electrolysis stack.
